(19) United States
(12) Patent Application Publication
(10) Pub. No.: US 2022/0403881 A1
(43) Pub. Date: Dec. 22, 2022

(54) CERAMIC BEARING ASSEMBLY

(71) Applicant: Transportation IP Holdings, LLC, Norwalk, CT (US)

(72) Inventors: Brandon Thomas Tolon, North East, PA (US); Corey Lee Jackson, Erie, PA (US); Dennis Richter, Erie, PA (US); Siddarth Prasanna Kumar, Bengaluru (IN)

(21) Appl. No.: 17/580,903

(22) Filed: Jan. 21, 2022

Related U.S. Application Data
(60) Provisional application No. 63/213,408, filed on Jun. 22, 2021.

(51) Int. Cl. F16C 33/32; F16C 19/04

(52) U.S. Cl. CPC F16C 33/32; F16C 19/04; F16C 2206/40

(57) ABSTRACT

A system is provided that may include a generator or alternator. A ceramic bearing assembly is within the alternator or generator. The ceramic bearing assembly may include one or more ceramic rolling elements formed of a ceramic material not including metal and disposed between a metallic inner race and an outer race of the ceramic bearing assembly.

### CROSS-REFERENCE TO RELATED APPLICATION

The present application claims priority to U.S. Provisional Application No. 63/213,408 filed Jun. 22, 2021, hereby incorporated by reference herein.

### BACKGROUND

### Technical Field

The subject matter described relates to a system and method for a ceramic bearing assembly.

### Discussion of Art

Different vehicles have different uses. Mining vehicles may haul tons of material to and from worksites. In addition to handling the unusually large amount of weight of the material being loaded into the mining vehicle, the vehicle may have multiple starts and stops. This operation may be on uneven or steep terrain. At the same time, such vehicles transport the materials from the worksite to a desired destination. While the engine of a vehicle may generate the torque required to start a loaded vehicle on any terrain, it must be able to travel at a maximum speed that is acceptable on a given highway. Mining vehicles are subject to operational duty that differs from other vehicles. Other specialized vehicles, such as locomotives, have operation specific parameters that may differ from those of other vehicles.

In some vehicles, an alternator may provide electric power. An overhaul interval, or life, of the alternator may be limited by the alternator bearing life. The alternator bearing life may be influenced by temperature generation in the bearing. Additionally, higher temperature may reduce grease life. Further, temperature differential within the bearing can affect bearing clearance, reducing the life of the bearing. It may be desirable to have methods and systems for bearing assemblies and bearings that are different than those that are commercially available.

### BRIEF DESCRIPTION

In one or more embodiments, a system is provided that can include a ceramic bearing assembly. The ceramic bearing assembly can include one or more ceramic rolling elements disposed between a metallic inner race and an outer race of the ceramic bearing assembly.

In one or more embodiments a system is provided that may include a generator or alternator. A ceramic bearing assembly may be coupled to the generator or alternator. The ceramic bearing assembly may also include one or more ceramic rolling elements formed of a ceramic material not including metal and disposed between a metallic inner race and an outer race of the ceramic bearing assembly.

In one or more embodiment a system is provided that may include a vehicle with one or more of an alternator or a generator may convert mechanical energy to electric energy. The system may also include a ceramic bearing assembly mounting on a shaft integrated to the alternator. The ceramic bearing assembly may include one or more ceramic rolling elements disposed between an inner race and an outer race of the ceramic bearing assembly.

### BRIEF DESCRIPTION OF THE DRAWINGS

The inventive subject matter may be understood from reading the following description of non-limiting embodiments, with reference to the attached drawings, wherein below:

FIG. 1A illustrates sectional view of an alternator/generator that includes a bearing assembly;

FIG. 1B illustrates a sectional view of a bearing assembly;

FIG. 1C illustrates a sectional view of a motor that includes bearing assemblies;

FIG. 2 illustrates a block schematic diagram of a mining vehicle system;

FIG. 3 illustrates a schematic diagram of an alternator electrically coupled to a motor;

FIG. 4 illustrates a block flow diagram of a method for reducing temperature of a bearing assembly that is operating in conjunction with a diesel engine of a mining vehicle;

FIG. 5 illustrates a graph of temperature rise of a bearing assembly over time;

FIG. 6 illustrates a graph of temperature rise of a bearing assembly over time; and

FIG. 7 illustrates a graph of temperature rise of a bearing assembly over time.

### DETAILED DESCRIPTION

Embodiments of the subject matter described herein may relate to systems and methods for a ceramic bearing assembly. This bearing assembly may be tailored for use in rotating equipment. Suitable rotating equipment may include, for example, an alternator or generator. These items of rotating equipment may be stationary or mobile. If mobile they may be disposed within a vehicle. Suitable vehicles may be automobiles, mining vehicles, rail vehicles, marine vessels, aircraft, on-road trucks, agricultural and industrial equipment, and the like. In particular, an alternator or a generator may be associated with an engine to convert mechanical power into electrical power. The hybrid ceramic bearing assembly may include numerous ceramic rolling elements that may be disposed between an inner race and an outer race of the hybrid ceramic bearing assembly. The ceramic rolling elements may have relatively lower mass and lower co-efficient of friction when compared to other commercially available bearings. A lower mass and lower co-efficient of friction may reduce temperature generation in the bearing during operation. This may result in a lower absolute temperature. By providing the ceramic rolling elements, the temperature generated by the bearing assembly may be reduced, increasing the life of the alternator/generator. The ceramic rolling elements may be more resilient to low lubrication film due to higher surface finish. The ceramic rolling elements may be relatively more resilient to false brinelling due to lower wear rate for the material combination of steel and ceramic. Specifically, such false brinelling may occur during shipping and handling with traditional bearings. Further, the reduced operating temperature may decrease the grease temperature and consequently increase grease life.

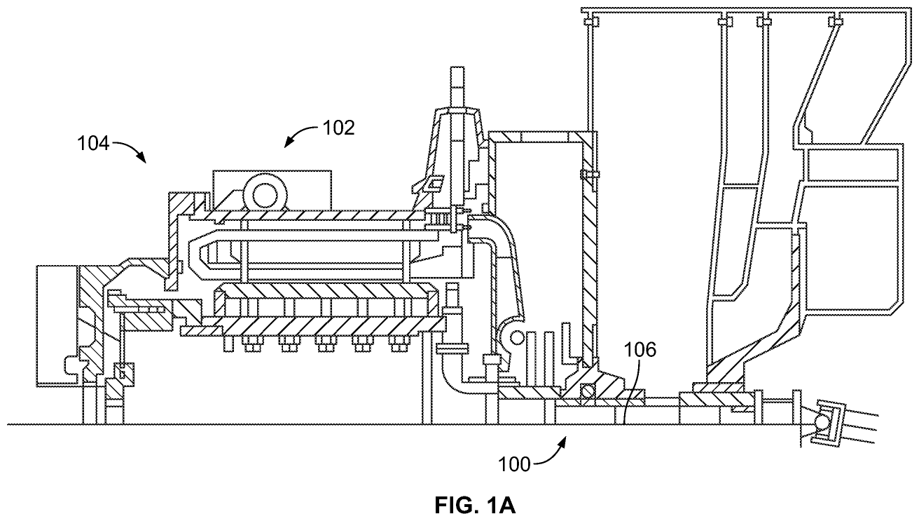

FIG. 1A illustrates a hybrid ceramic bearing assembly 100 that is provided in association with an alternator 102 that is coupled to an engine 104. In the illustrated embodiment, the engine is a diesel engine. In some embodiments, the alternator may be a generator. A shaft 106 may be integrated to the alternator. The bearing of the bearing assembly is mounted on the shaft during equipment assembly. In one example, only a single bearing assembly is provided in the alternator. The illustrated engine is a diesel engine.

As illustrated in the sectional view of the hybrid ceramic bearing in FIG. 1B, the bearing may include an inner race 108 that engages and is rotated by the shaft. A suitable inner race may be a metal, a plastic, a ceramic, or a combination of the foregoing. The inner race may be secured or coupled to the shaft. Suitable coupling methods may include friction fit to the shaft, mechanical fastening, welding, and the like. In one embodiment, the hybrid ceramic bearing assembly may include an outer race 110 that is radially spaced from the inner race. The outer race in one example may engage an outer wall 112 of a housing 114. This engagement may prevent rotation of the outer race relative to the inner race. In one example, the outer race is made of the same material as the inner race. In one embodiment, the inner and outer races are formed from materials different from each other, including different metals or metal alloys.

Disposed between the inner race and the outer race may be a raceway 116 that receives plural ceramic rolling elements 118. The raceway may arcuately extend around the perimeter of the inner race and is of size and shape to receive each of the plural ceramic rolling elements. In one example, the plural ceramic rolling elements may be received by a cage 119. The ceramic rolling elements rotate about the shaft with the inner race, rolling or moving about the stationary outer race. By having ceramic rolling elements disposed between the inner race and outer race, the amount of friction created between the moving rolling elements may be less than if the inner race engaged the outer race directly.

Suitable ceramic rolling elements may be spherical, cylindrical, conical, tapered, or the like and selected based on end use parameters. Suitable ceramic rolling elements may be solid, hollow, or filled with cells. Suitable ceramic rolling elements may be coated with ceramic, in one embodiment, may have a ceramic core in another embodiment, or may be homogenous (and ceramic) with regard to the material throughout.

The hybrid ceramic bearing assembly may be made from a ceramic material. Suitable ceramic materials may include pure ceramic or cermet materials. Each ceramic rolling element may include at least a portion of the ceramic rolling element that is made from a ceramic material. To this end, in one embodiment, each of the ceramic rolling elements may be a ceramic material without any other material. In one example, a ceramic rolling element may include both ceramic and metallic materials. For example, a ceramic rolling element may be made of 99.99% ceramic by weight, and 0.01% of an alternative material by weight, including metal. In another example, the ceramic rolling element may be made of 0.01% ceramic by weight, and 99.99% alternative material such as metal by weight. In another example, the ceramic rolling element may be at least 50% a ceramic material by weight. In other examples, the ceramic rolling element may be at least 20% a ceramic material by weight. Based on the end use application, a suitable ceramic may be selected with reference to its melting temperature, hardness, conductivity, moduli of elasticity, chemical resistance, and ductility. The end use application's requirements strongly influence the choice of bearing material. The heavier duty the requirements are on the bearings, the more selective the material selection will be. Suitable ceramic material include inorganic, non-metallic materials. In one embodiment, the ceramic is selected from crystalline oxide, nitride, or carbide materials. In one embodiment, the ceramic may include carbon or silicon. In one embodiment, the ceramic may include aluminum oxide (alumina), silicon carbide and/or tungsten carbide. In one embodiment, a suitable ceramic is a ceramic matrix composite (CMC). In one embodiment, the ceramic is an oxide. In one embodiment, the ceramic is a non-oxide. In one embodiment, the ceramic is a composite material. Suitable oxides may include one or more of alumina, beryllia, ceria, and zirconia. Suitable non-oxides may include one or more carbide, boride, nitride, and silicide. In one example, Si3N4, silicon nitride is utilized as the rolling element. Meanwhile, in one embodiment an aluminum oxide coating is utilized to insulate an inner race, outer race, or both to reduce heat transfer. With reference to the foregoing, suitable composite materials may be particulate reinforced, fiber reinforced, and may be combinations of oxides and non-oxides. Specifically, the heat transfer and temperature differential of the ceramic material of the rolling element compared to steel rolling elements is unexpected. While a reduction in temperature is expected, instead the significant temperature reduction was unexpected and beyond a mere material change. The heat transfer properties, reduction in weight and friction, reduction in sheer forces, etc. combined for the significant temperature reduction. To this end, merely coating a steel bearing element with ceramic material in an attempt to achieve the heat transfer advantage would not result in the significant reduction in temperature as observed when a completely ceramic bearing element is provided.

By providing a ceramic rolling element, the co-efficient of thermal expansion (CTE) may be decreased compared to a steel rolling element. In addition, the ceramic rolling elements may have both a lower mass and a lower co-efficient of friction compared to steel rolling elements. A low CTE may help retain bearing internal clearance during operating conditions. There may be a reduction of temperature generation in the bearing and thus lower absolute temperature. Consequently, bearing life is increased, while grease life is increased as a result of the decreased operating temperatures. In one embodiment, the ceramic rolling elements may be resilient to low lubrication film due to a relatively higher surface finish. In one embodiment, the ceramic rolling elements may be relatively more resilient to false brinelling that generally occurs, such as during shipping and handling. Suitable ceramic rolling elements may be relatively resistant to low lubricating film situations as well as resistant to damage related to shipping, shocks, or other anomalies in shipping, handling, and operation.

The performance of the ceramic rolling elements may be improved relative to insulated steel bearings, which do not reduce the temperature generation in a bearing system to the extent a hybrid ceramic bearing may reduce temperature generation. In one embodiment, a hybrid ceramic bearing assembly can operate at a same load, speed, and size of a bearing assembly that does not utilize ceramic rolling elements. There may be a relative improvement in performance regarding reduced failures in the hybrid ceramic bearing assembly due to heat and temperature differentials.

FIG. 1C illustrates an alternative embodiment that includes a first hybrid ceramic bearing assembly 100C and second hybrid ceramic bearing 101C that are both provided in association with a motor 102C. In some embodiments, a motor may provide torque for the wheels of a vehicle, including the wheels of a mining vehicle. To this end, a shaft 106C may be integrated to the motor. The bearing element of the first bearing assembly may be a spherical bearing element, whereas the bearing element of the second bearing assembly may be a cylindrical bearing element. Alternatively, the bearing elements may include other shapes as described in detail herein. In one example, only the first hybrid ceramic bearing assembly is a hybrid ceramic bearing assembly. Similarly, in other examples, only the second hybrid ceramic bearing assembly is a hybrid ceramic bearing assembly.

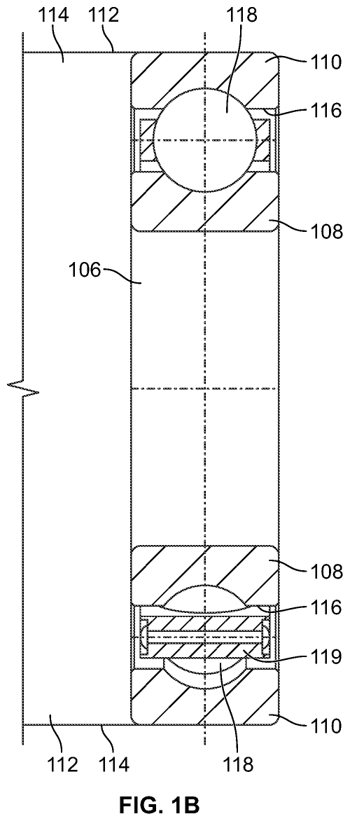

FIG. 2 illustrates a schematic diagram of a mining vehicle system 200 that may include a mining truck body 202 that receives a movable truck bed 204. The movable truck bed may receive mining materials for hauling from a worksite. Such mining material may include coal, ore, dirt, or the like.

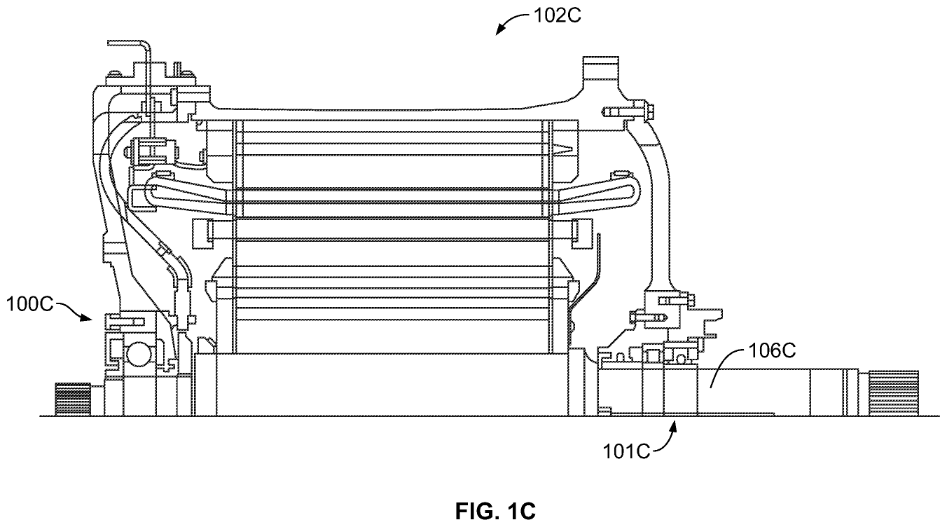

The mining vehicle system additionally may include a traction assembly 206 that has plural wheels 208. The traction assembly may also include at least one axle 210 that is rotated by a prime mover assembly 212. In another embodiment, the traction assembly may include individual motors (FIG. 3) that are powered by the prime mover assembly to rotate wheels individually. The prime mover assembly may include an engine 214 that may include an output shaft coupled to an alternator 216 or generator 218. In one example, the engine is a diesel engine.

The alternator or generator functions as either an alternator or a generator depending on the output electrical waveform (AC vs. DC). In addition, the alternator or generator can convert mechanical power into electrical power, or convert electrical power into mechanical power depending on the rotational direction of the output shaft. Still, the alternator provides the motive force for the at least one axle to drive the wheels. In one embodiment, the engine and alternator combine to provide a greater than 3500 horsepower (HP) or 2600 kilowatts (kW) output to drive wheels of the mining vehicle system.

FIG. 3 illustrates a schematic block diagram of an alternator 300 electrically coupled to a motor 302 may propel a wheel of a vehicle. In the embodiment of FIG. 3, after the alternator converts the mechanical power of an engine into electric power, and the alternator powers a motor to propel an individual wheel of a vehicle. As illustrated, the alternator may be coupled to driving circuitry 304 that may include a rectifier 306, a DC link capacitor 308, and an inverter 310 to provide an input for the motor. In this manner, the alternator may provide power for both propulsion and auxiliary power for an entire vehicle.

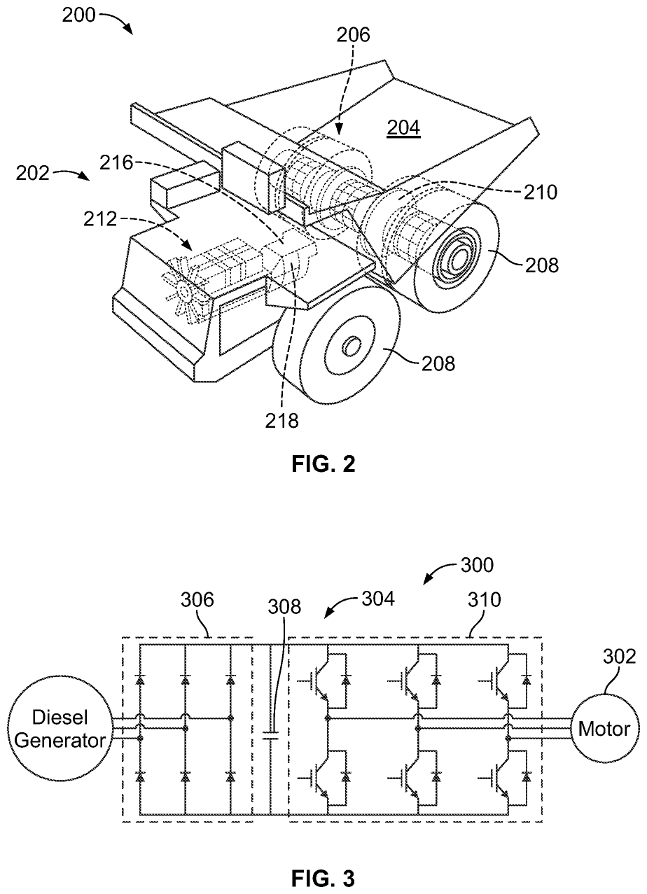

FIG. 4 illustrates a method 400 for reducing temperature of a hybrid ceramic bearing assembly that is operating in conjunction with a diesel engine of a vehicle system. In one example, the hybrid ceramic bearing assembly is the hybrid ceramic bearing assembly of the alternator of FIG. 2, and the vehicle system is the vehicle system of FIG. 1.

At step 402, a hybrid ceramic bearing assembly is coupled with one or more of an alternator or a generator that is onboard a vehicle. In one embodiment, only a single bearing assembly is provided. In one embodiment, the vehicle is a vehicle system. In other embodiments, the vehicle may be an off road vehicle, trolley, tractor trailer, backhoe, combine, etc. that utilizes a diesel engine, and particularly a diesel engine for producing greater than 3500 horsepower (HP) or 2600 kilowatts (kW) output. In one example, the alternator or the generator are onboard the vehicle by being coupled to vehicle housing in a position to couple to an engine of the vehicle system.

At step 404, the hybrid ceramic bearing assembly includes a shaft that may be integrated to an alternator. The hybrid ceramic bearing can include ceramic rolling elements that in example embodiments are any of the ceramic rolling elements as described in relation to FIG. 2. In one such example, the ceramic rolling elements are formed only from a ceramic material and do not include metal. In another example, the ceramic rolling elements are ceramic rolling elements wherein a portion of a rolling element is ceramic, while another portion of the rolling element is metallic. In particular, by providing ceramic rolling elements, wear resulting from mechanical use may be limited by utilizing the metallic material of the inner and outer races, while temperature generation and differential is reduced by the ceramic material in the ceramic rolling elements. In this manner, the hybrid ceramic bearing assembly provides both wear resistance and temperature reduction.

At step 406, the temperature generated as a result of the ceramic rolling elements, and temperature differential between the inner race and outer race are reduce compared to a bearing assembly utilizing metallic rolling elements. Specifically, the one or more ceramic rolling elements are less thermally conductive than the inner race and the outer race of the hybrid ceramic bearing assembly. As a result, the hybrid ceramic bearing assembly provides a reduced temperature differential between the inner race and the outer race relative to another bearing assembly having one or more metal rolling elements. Consequently, improved grease efficiency, and consequently alternator life, and thus engine life may be extended.

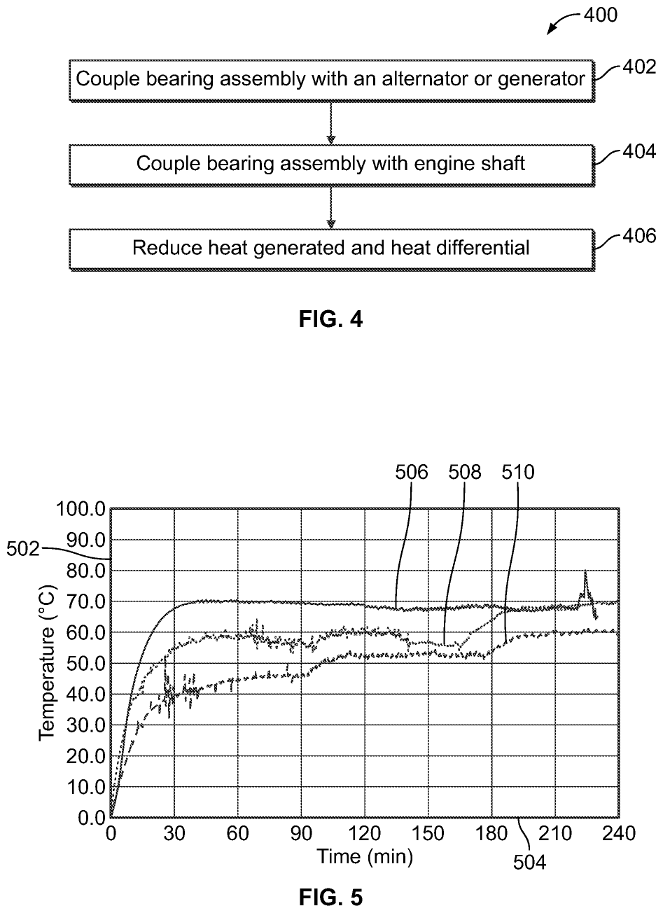

FIG. 5 is a graph of a comparison of mechanical temperature produced by the same alternator when using steel bearings as compared to ceramic rolling elements in a hybrid ceramic bearing assembly. The graph is presenting the temperature rise over ambient 502 in degrees Celsius (° C.) over time 504 in minutes. Line 506 shows the temperature measured from the use of the steel bearings that elevates and holds at approximately 70° C., whereas line 508 shows a first run of ceramic rolling elements where the temperature elevates and holds at around 60° C., before eventually going to 70° C. In addition, line 510 illustrates a second run of the ceramic rolling elements where the temperature elevates and holds at around 50° C., then around 55° C., and finally at 60° C. In each instance, the temperature differential for the hybrid ceramic bearing assembly is significantly less over time than the bearing assembly using steel bearings.

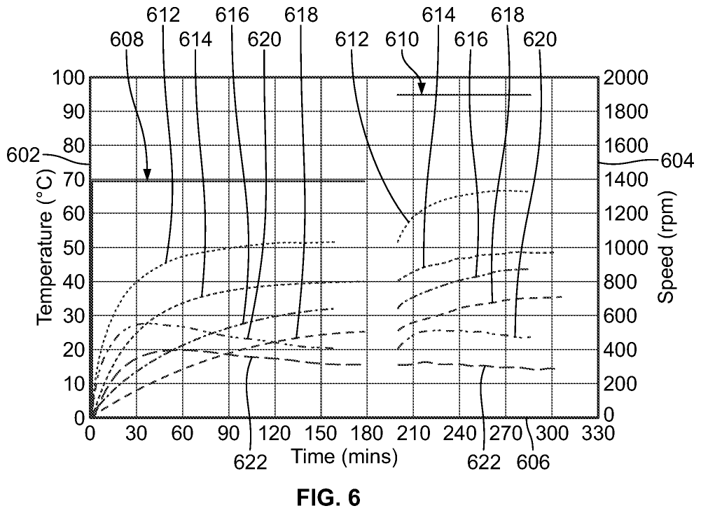

FIG. 6 illustrates another comparison of a hybrid ceramic bearing assembly to a bearing assembly utilizing steel bearings when providing different revolutions per minute (rpm) over time. The graph may include an axis for temperature rise over ambient 602 in ° C. and speed 604 in rpm over time 606 in minutes. The left side 608 of the graph represents the change in temperature over time at 1400 rpm, whereas the right side 610 of the graph represents the alternator at 1900 rpm. Line 612 represents the temperature of the inner ring of a bearing system using steel bearings, while line 614 represents the temperature of the inner ring of a hybrid ceramic bearing assembly using the ceramic rolling elements. Similarly, line 616 represents the temperature of the outer ring of a bearing assembly using the steel bearings, while line 618 represents the temperature of the outer ring of a hybrid ceramic bearing assembly using ceramic rolling elements. Meanwhile, line 620 represents the temperature difference, delta, between the inner race and the outer race for the bearing assembly using the steel bearings, and line 622 represents the delta of the inner race and outer race for the hybrid ceramic bearing assembly. In each instance, for the same alternator, the hybrid ceramic bearing assembly over time provided a reduction of temperature on both the inner ring and outer ring, along with a reduction in the delta temperature between the inner race and outer race. As an example, an increase in temperature differential between the inner race and the outer race is less than 20 degrees Celsius when the system is operating in a range between 1400 and 1900 revolutions per minute for a period of less than 3 minutes. As a result of this significant and substantial reduction in temperature, and delta temperature, less wear on the inner ring and outer ring is presented. In addition, the temperature of the grease used within the bearing system similarly is decreased. As such, fatigue within the bearing system as a result of prolonged temperature exposure is reduced, increasing the life of the bearing system.

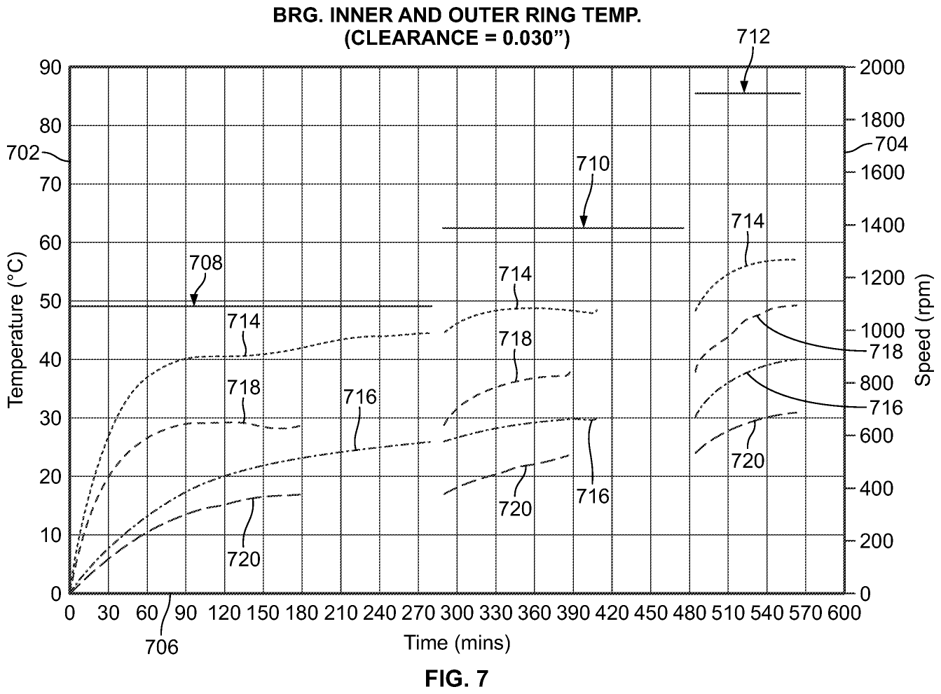

FIG. 7 illustrates a graph of a hybrid ceramic bearing assembly that has a clearance of 0.030 inches. The graph may include an axis showing temperature rise over ambient 702 in degrees Celsius, speed 704 in rpms, time 706 in minutes. On the left side 708 of the graph, the alternator was operated at 1100 rpm, in the middle 710 of the graph the alternator was operated at 1400 rpm, and at the right side 712 of the graph the alternator was operated at 1900 rpm. In the graph, line 714 represents the temperature of the inner race of a bearing assembly using steel bearings, line 716 represents the temperature of the inner race of a hybrid ceramic bearing assembly, line 718 represents the temperature of the outer race of a bearing assembly using steel bearings, and line 720 represents the temperature of the outer race of a hybrid ceramic bearing assembly. As also illustrated in the previous graphs, by using the hybrid ceramic bearing assembly both temperature and delta temperature is decreased, improving health of the bearing assembly, and life of the bearing grease. Similar to the example of FIG. 7, an increase in temperature differential between the inner race and the outer race is less than 20 degrees Celsius when the system is operating in a range between 1100 and 1900 revolutions per minute for a period of less than 3 minutes.

In one or more embodiments, a system is provided that has an alternator disposed onboard a vehicle. The system can convert rotary motion from an engine shaft into electric energy. In addition, the system can include a hybrid ceramic bearing assembly for an alternator or the generator. The hybrid ceramic bearing assembly may include one or more ceramic rolling elements disposed between an inner race and an outer race of the hybrid ceramic bearing assembly.

Optionally, the one or more ceramic rolling elements may be formed from a ceramic material and do not include metal. In one aspect, the alternator and the hybrid ceramic bearing assembly may be disposed onboard a vehicle. In another aspect, the hybrid ceramic bearing assembly may be a single bearing assembly.

Optionally, the one or more ceramic rolling elements may be less thermally conductive than the inner race and the outer race of the hybrid ceramic bearing assembly. In one example the hybrid ceramic bearing assembly can provide a reduced temperature differential between the inner race and the outer race relative to another bearing assembly having one or more metal rolling elements. In another example, the system may include the alternator, and the hybrid ceramic bearing assembly may include the one or more ceramic rolling elements formed only from a ceramic material.

In one or more embodiments, a method is provided that may include providing a hybrid ceramic bearing assembly within one or more of an alternator or a generator that is onboard a vehicle. The hybrid ceramic bearing assembly may include one or more ceramic rolling elements disposed between an inner race and an outer race of the bearing assembly.

Optionally, the one or more ceramic rolling elements may be formed from a ceramic material and do not include metal. In one example, the vehicle may be a mining vehicle. In another example, the hybrid ceramic bearing assembly may be a single bearing assembly. In one aspect, the one or more ceramic rolling elements may be less thermally conductive than the inner race and the outer race of the hybrid ceramic bearing assembly. In another aspect, the hybrid ceramic bearing assembly may provide a reduced temperature differential between the inner race and the outer race relative to another bearing assembly having one or more metal rolling elements. In another embodiment, the hybrid ceramic bearing assembly may be coupled with the alternator. The hybrid ceramic bearing assembly may include the one or more ceramic rolling elements formed only from a ceramic material, and the vehicle is a mining vehicle.

In one or more embodiments a mining vehicle is provided that may include one or more of an alternator or a generator may covert rotary motion from an engine shaft to electric energy. The mining vehicle may also include an engine may rotate the engine shaft, and a hybrid ceramic bearing assembly within the alternator or generator. The hybrid ceramic bearing assembly may include one or more ceramic rolling elements disposed between an inner race and an outer race of the bearing assembly.

Optionally, the one or more ceramic rolling elements may be formed from a ceramic material and do not include metal. In one aspect, the hybrid ceramic bearing assembly may be a single bearing assembly. In another aspect, the one or more ceramic rolling elements may be less thermally conductive than the inner race and the outer race of the hybrid ceramic bearing assembly. In one example, the hybrid ceramic bearing assembly may reduce a temperature differential between the inner race and the outer race relative to another bearing assembly having one or more metal rolling elements. In another aspect, the mining vehicle may include one or more traction motors that are powered by the electric energy from the alternator and that propel the mining vehicle.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
a ceramic bearing assembly comprising one or more ceramic rolling elements disposed between a metallic inner race and an outer race of the ceramic bearing assembly.

2. The system of claim 1, wherein the one or more ceramic rolling elements are formed from a ceramic material and the ceramic does not include metal.

3. The system of claim 1, further comprising a generator or alternator, and the ceramic bearing assembly is coupled to the generator or alternator via a shaft, and the system is configured to be disposed onboard a mining vehicle.

4. The system of claim 1, wherein the ceramic bearing assembly is a hybrid ceramic bearing in a single-bearing assembly.

5. The system of claim 1, wherein the one or more ceramic rolling elements are less thermally conductive than either of the inner race or the outer race of the hybrid ceramic bearing assembly.

6. The system of claim 1, wherein the hybrid ceramic bearing assembly provides a reduced co-efficient of thermal expansion during operation between the inner race and the outer race relative to another bearing assembly having one or more metal rolling elements.

7. The system of claim 1, wherein the system includes a generator or alternator, the hybrid ceramic bearing assembly includes the one or more ceramic rolling elements formed only from a ceramic material.

8. The system of claim 1, wherein the one or more ceramic rolling elements are at least one of spherical, cylindrical, tapered, or conical.

9. The system of claim 1, wherein the one or more ceramic rolling elements are at least one of hollow or filled with cells.

10. The system of claim 1, wherein an increase in temperature differential between the metallic inner race and the outer race is less than 20 degrees Celsuis when the system is operating in a range between 1100 and 1900 revolutions per minute for a period of less than 3 minutes.

11. A system comprising:
a generator or alternator; and
a ceramic bearing assembly coupled to the generator or alternator and comprising one or more ceramic rolling elements formed of a ceramic material not including metal and disposed between a metallic inner race and an outer race of the ceramic bearing assembly.

12. The system of claim 11, wherein the ceramic bearing assembly is a hybrid ceramic bearing, single bearing assembly.

13. The system of claim 1, wherein the one or more ceramic rolling elements are less thermally conductive than either of the inner race or the outer race of the hybrid ceramic bearing assembly.

14. The system of claim 1, wherein the hybrid ceramic bearing assembly provides a reduced co-efficient of thermal expansion during operation between the inner race and the outer race relative to another bearing assembly having one or more metal rolling elements.

15. The system of claim 11, wherein an increase in temperature differential between the metallic inner race and the outer race is less than 20 degrees Celsuis when the system is operating in a range between 1100 and 1900 revolutions per minute for a period of less than 3 minutes.

16. A vehicle comprising:
one or more of an alternator or a generator configured to convert mechanical energy to electric energy; and
a ceramic bearing assembly within the alternator or the generator, the ceramic bearing assembly comprising one or more ceramic rolling elements disposed between an inner race and an outer race of the ceramic bearing assembly.

17. The vehicle of claim 16, wherein the one or more ceramic rolling elements consists essentially of ceramic.

18. The vehicle of claim 16, wherein the ceramic bearing assembly is a single bearing assembly.

19. The mining vehicle of claim 16, wherein the one or more ceramic rolling elements are less thermally conductive than the inner race and the outer race of the hybrid ceramic bearing assembly.

20. The mining vehicle of claim 16, wherein the ceramic bearing assembly provides a reduced co-efficient of thermal expansion during operation between the inner race and the outer race relative to another bearing assembly having one or more metal rolling elements.
